(19) United States
(12) Patent Application Publication
(10) Pub. No.: US 2026/0017378 A1
(43) Pub. Date: Jan. 15, 2026

(54) PRIVACY-AWARE DYNAMIC ATTACK PATH EXPLAINER

(71) Applicant: Palo Alto Networks, Inc., Santa Clara, CA (US)

(72) Inventors: Ajaya Neupane, San Jose, CA (US); Alok Tongaonkar, San Jose, CA (US)

(21) Appl. No.: 18/767,688

(22) Filed: Jul. 9, 2024

(51) Int. Cl. G06F 21/57

(52) U.S. Cl. CPC G06F 21/577; G06F 2221/034

(57) ABSTRACT

Various techniques for providing a privacy-aware dynamic path explainer are disclosed. In some embodiments, a system, a process, and/or a computer program product for a privacy-aware dynamic path explainer includes receiving a graph of a network that includes one or more vulnerabilities and/or one or more risk findings (e.g., the graph can also include one or more systems and/or one or more misconfigurations); contextualizing the graph of the network; generating one or more prompts and inputting the contextualized graph to a Large-Language Model (LLM); and generating an output that summarizes the contextualized graph using the LLM.

### BACKGROUND OF THE INVENTION

Large Language Models (LLMs) are typically trained on publicly available documents. As a result, they may struggle to answer domain-specific questions if such documents were not included in their training data. Retrieval-Augmented Generation (RAG) is an architecture used for knowledge-based question answering, particularly useful when the required data was not part of the model's training set.

RAG can reduce the likelihood of hallucination in LLM responses, though it does not eliminate them entirely. There are several potential failure points in a RAG-based approach that can impact the reliability of the responses. For example, if irrelevant or conflicting documents are retrieved, it may cause the LLM to generate hallucinated responses. Additionally, the absence of relevant documents can also lead to hallucinations in the LLM response.

### BRIEF DESCRIPTION OF THE DRAWINGS

Various embodiments of the invention are disclosed in the following detailed description and the accompanying drawings.

FIG. 1 illustrates an overall system architecture of a privacy-aware dynamic attack path explainer system in accordance with some embodiments.

FIG. 2 illustrates example components of a system for a privacy-aware dynamic attack path explainer solution in accordance with some embodiments.

FIG. 3 illustrates an example attack path graph in JSON format in accordance with some embodiments.

FIG. 4 illustrates an example prompt generation in accordance with some embodiments.

FIG. 5 illustrates an example generative model response in accordance with some embodiments.

FIG. 6 illustrates an example output of a system for a privacy-aware dynamic attack path explainer solution in accordance with some embodiments.

FIG. 7 illustrates example results of experiments performed using the privacy-aware dynamic attack path explainer solution in accordance with some embodiments.

FIG. 8 is a flow diagram for a process for providing a privacy-aware dynamic path explainer in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Large Language Models (LLMs) are typically trained on publicly available documents. As a result, they may struggle to answer domain-specific questions if such documents were not included in their training data. Retrieval-Augmented Generation (RAG) is an architecture used for knowledge-based question answering, particularly useful when the required data was not part of the model's training set.

RAG can reduce the likelihood of hallucination in LLM responses, though it does not eliminate them entirely. There are several potential failure points in a RAG-based approach that can impact the reliability of the responses. For example, if irrelevant or conflicting documents are retrieved, it may cause the LLM to generate hallucinated responses. Additionally, the absence of relevant documents can also lead to hallucinations in the LLM response.

### Overview of Techniques for Providing a Privacy-Aware Dynamic Path Explainer

Various enterprise network and security related solutions have various policies to, for example, find and display the assets at risk and the potential attack paths created for an attacker. These risks may include vulnerabilities, misconfigurations, high-privileged roles, anomalies, and Internet exposure.

However, the users of most enterprise network and security related solutions typically have a variety of different technology backgrounds (e.g., development operations (devops), engineers, and executives) and often do not understand the attack path, and the critical risks these attack paths are depicting. Specifically, users generally find it difficult to understand and communicate complex combinations of risks present in an attack path graph.

Also, although Large Language Models (LLMs) are being applied to perform various encoding and decoding tasks, LLMs still cannot effectively explain large graphs. Moreover, existing LLMs often hallucinate and provide generic answers.

Thus, new and improved solutions for automatically explaining potential security issues associated with a network (e.g., an enterprise network) are needed.

Specifically, there exists a need for a methodology that explains the risks associated with these attack paths to the end users.

However, generating an explanation for any dynamic graph depending on the user's environment is a technically challenging task. Moreover, such would require a solution that can also explain the risks in the context the user understands.

In addition, these graphs are often very large (e.g., greater than one gigabyte (GB)) in size and transferring them across the servers for analysis is costly in terms of price and latency.

Accordingly, various techniques for providing a privacy-aware dynamic path explainer are disclosed.

In some embodiments, a system, a process, and/or a computer program product for a privacy-aware dynamic path explainer includes receiving a graph of a network that includes one or more vulnerabilities and/or one or more risk findings (e.g., the graph can also include one or more systems and/or one or more misconfigurations); contextualizing the graph of the network; generating one or more prompts and inputting the contextualized graph to a Large-Language Model (LLM); and generating an output that summarizes the contextualized graph using the LLM. The dynamic path is any combination of Internet exposures, vulnerabilities, misconfigurations, present in one or more systems connected by a network.

In one embodiment, the tenant proprietary data can be obfuscated in the graph prior to inputting the graph into the LLM.

In one embodiment, the attack path explanation can be included in the output that summarizes the contextualized graph using the LLM (e.g., a critical path explanation can be included in the output that summarizes the contextualized graph using the LLM).

In one embodiment, an alert explanation is included in the output that summarizes the contextualized graph using the LLM.

In one embodiment, guardrails are used to reduce hallucinations in the output generated using the LLM.

In one embodiment, the one or more prompts include one or more predetermined prompts that are input to the LLM.

In one embodiment, the graph information is stored in a JavaScript Object Notation (JSON) format for input and/or output.

In some embodiments, a system, a process, and/or a computer program product for a privacy-aware dynamic path explainer includes compressing the graph.

In some embodiments, a system, a process, and/or a computer program product for a privacy-aware dynamic path explainer includes grounding information in context input to the LLM based on a predetermined set of Common Vulnerabilities and Exposures (CVEs).

For example, the disclosed techniques for providing a privacy-aware dynamic path explainer can minimize the needs of experts (e.g., computer security experts) to explicitly explain every combination of risks associated with their enterprise network environment (e.g., a cloud-based computing environment using Prisma Cloud that is commercially available from Palo Alto Networks, Inc., headquartered in Santa Clara, CA, or another enterprise network computing environment), such as will be further described below.

Also, the disclosed techniques for providing a privacy-aware dynamic path explainer reduce the latency and costs associated with identifying such risks with their enterprise network environment, such as will be further described below.

Further, the disclosed techniques for providing a privacy-aware dynamic path explainer reduce the hallucinations typically associated with using an LLM to generate responses, such as will be further described below.

In addition, the disclosed techniques for providing a privacy-aware dynamic path explainer protect customer private information from leaking, such as will be further described below.

Moreover, the disclosed techniques for providing a privacy-aware dynamic path explainer facilitate a common language for communication of security risks to various stakeholders associated with the enterprise (e.g., including explanations of complex connected risks in attack path graphs and how such risks could be exploited), such as will be further described below.

Additional system embodiments and techniques for providing a privacy-aware dynamic path explainer will now be further described below.

### Example System Embodiments for Providing a Privacy-Aware Dynamic Path Explainer

Recent advances in Large-Language Model (LLM) related Artificial Intelligence (AI)/Machine Learning (ML) (e.g., including deep learning ML techniques (MLT)) provide access to various AI/ML models (e.g., specifically, LLMs) that can automatically generate responses for various questions a user asks.

However, the current LLM technology has certain technical limitations. For example, the current LLM technology is not effective in understanding large graph structured data. Also, most existing LLMs have a limited context window. In addition, the current LLMs exhibit well-known hallucinations (e.g., false fact generations). Finally, using LLMs presents privacy risks (e.g., if the input in a context window to an LLM includes enterprise network computing priority information, then providing such information to the LLM is a privacy/proprietary data risk to the enterprise).

As such, the disclosed techniques for providing a privacy-aware dynamic path explainer solve these technical challenges as will now be further described below.

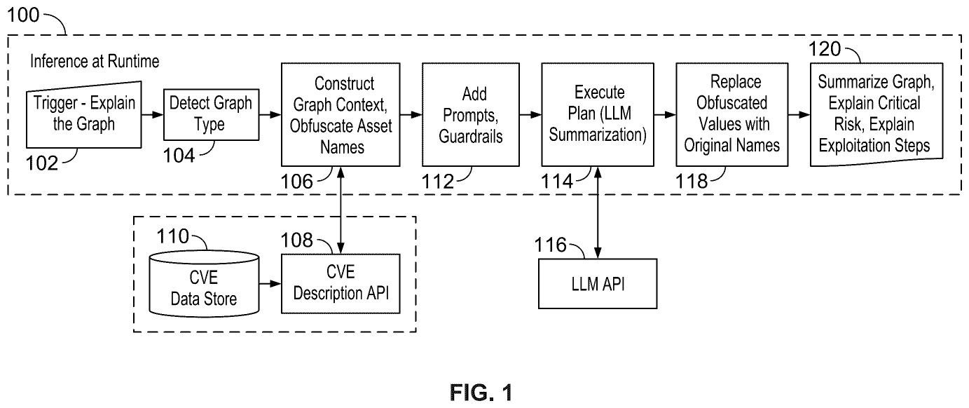

FIG. 1 illustrates an overall system architecture of a privacy-aware dynamic attack path explainer system in accordance with some embodiments. Generally, the disclosed privacy-aware dynamic path explainer system as shown in FIG. 1 provides a solution that can explain the risks present in a given attack path graph without sending the entire graph to LLM, keeping the private information within premise, fitting within the content length limitation of a large language model, reducing hallucinations, and producing structured output to be consumed by UI.

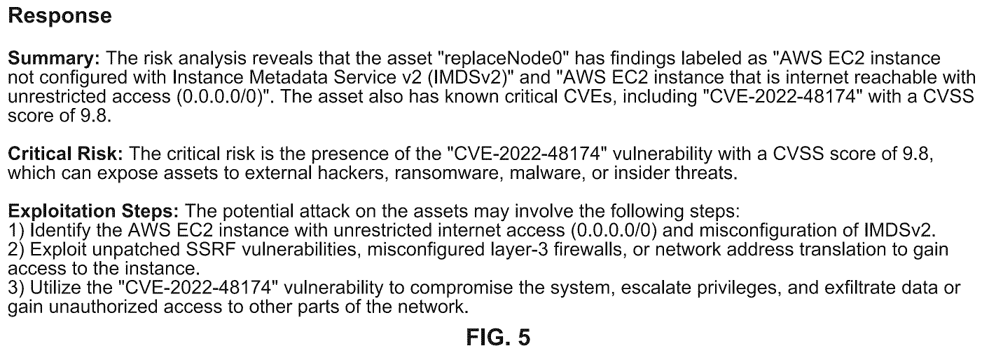

Specifically, in this example implementation, the system (100) includes the following components: (1) a summarizer, which receives the input graph and prepares an intermediate representation to query a model for risk explanations; (2) a decoder model (e.g., an API for calling an LLM service for performing inferences based on the input graph and prompts), which receives the intermediate representation of the graph (e.g., dynamic attack path graph) and generates explanations; (3) prompts (e.g., a set of questions/predetermined prompts) that guide the decoder model to generate appropriate responses to the graph, such as shown in FIG. 5; and (4) guardrails (e.g., for obfuscating the private information and preventing the LLM from generating inappropriate responses, such as hallucinations), which are each further described below.

Referring to FIG. 1, at 102, during inference at runtime (100) using the LLM, a trigger event is used to explain the graph (e.g., an input attack path graph). Specifically, the LLM is prompted to ingest a graph that includes structured data and explain the dynamic contextual risks depicted in the graph in concise natural language, such as shown in FIG. 5 and as will be further described below.

At 104, the graph type is detected. For example, a graph can be in JavaScript Object Notation (JSON) format (e.g., and/or other formats can similarly be used). In this example implementation, the graph is a dynamic attack path graph as further described herein.

At 106, the graph context is constructed, and certain information associated with the graph is obfuscated. In this example implementation, asset names associated with the graph are obfuscated to remove private information. In addition, the graph can be linearized to reduce the graph size and latency in processing the requests and generating responses.

At 108, the graph is annotated using a CVE description Application Programming Interface (API) that extracts relevant CVEs from a CVE data store as shown at 110.

At 112, prompts (e.g., a set of questions) and guardrails are added to append with the linearized graph and query the LLM (e.g., a decoder model, which can be provided using a decoder LLM, such as further described herein). In this example implementation, the decoder model is trained to generate new tokens, to summarize the contextual risks present in the graph, identify the most critical risk to address, and the steps that an attacker can use to exploit these risks if not addressed adequately, such as will be further described below. More specifically, in this example implementation, the graph representing contextual risks at various vantage points for an enterprise network environment is converted to a natural language query (e.g., converting nodes as the nouns and the relationships as the contextual relationships), and we can then query the decoder model trained to generate new tokens to explain the contextual risks as a summary that identifies various critical risks and exploitation steps, such as will be further described below. Also, in this example implementation (e.g., of the guardrails), the query can be grounded with the vulnerability information and the risk description to prevent the decoder model from generating an incorrect explanation (e.g., hallucination).

At 114, plan execution is performed. Specifically, the LLM is called using an LLM API as shown at 116. As similarly described above, the LLM is prompted to ingest the attack path graph and to generate a summary of the contextual risks present in the graph, identify the most critical risk to address, and the steps that an attacker can use to exploit these risks if not addressed adequately, such as shown in FIG. 5 and as will be further described below.

At 118, the obfuscated values (e.g., obfuscated asset names as performed at 106 for anonymizing the attack path graph data for confidential/proprietary data associated with a given enterprise network associated with the graph, such that this confidential/proprietary information is not sent to/shared with a third party LLM provider) are replaced with the original names/values.

At 120, summarizing the graph, explaining the critical risks, and explaining the exploitation steps are output. For example, the output can explain the dynamic contextual risks present in an enterprise network, such as similarly described above and further described below.

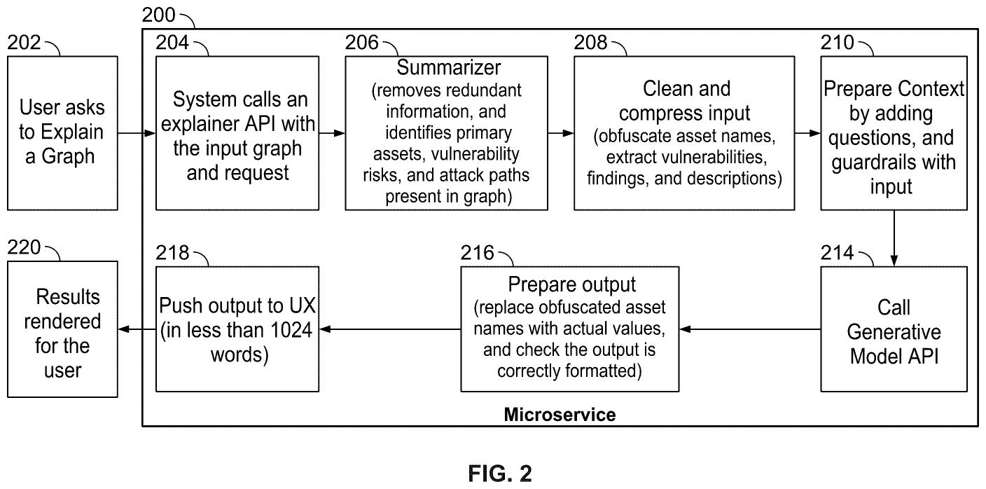

FIG. 2 illustrates example components of a system for a privacy-aware dynamic attack path explainer solution in accordance with some embodiments. Specifically, FIG. 2 illustrates a microservice 200 that includes example components of a system implementation for providing a privacy-aware dynamic attack path explainer service.

At 202, a user asks the privacy-aware dynamic attack path explainer service (200) to explain a graph (e.g., a dynamic attack path). Examples of questions that the disclosed service/system can answer include: (1) an explanation of the dynamic attack path graph (e.g., what do I see in the graph); (2) what are the critical risks associated with the dynamic attack path graph; and (3) how an attacker can exploit the critical risks. As similarly described above, the disclosed service/system facilitates providing an explanation of the dynamic attack path and alerts to allow users (e.g., enterprise customers) to better understand the risks, relevance, application (app) context, and real-world exploitations associated with their enterprise network environment.

At 204, the system calls an explainer API with the input graph and the request (202).

At 206, a summarizer component processes the input graph to perform the following: removes redundant information and identifies primary assets, vulnerability risks, and attack paths present in the graph. Specifically, in this example implementation, the summarizer can perform compression of the contexts from the structured data included in the graph. For example, instead of sending the entire set of graph data to the LLM, the graph is linearized into an intermediate representation (e.g., a linearized graph context, as will now be further described). More specifically, the summarizer receives the graph in a given input specification (e.g., in a JSON format), and identifies the assets, misconfigurations, over-privileged roles, gateways, and other risks present in the graph. For each of the identified risks, the summarizer generates a context with the assets and risks, and for each critical CVE, the summarizer generates a context with the CVE description from the CVE data store (e.g., as shown at 110 in FIG. 1). The summarizer then prepares a paragraph by merging these asset-risk contexts and vulnerabilities together into a textual paragraph, which is referred to herein as a linearized graph context.

At 208, the graph input is cleaned and compressed. Specifically, as similarly described above with respect to FIG. 1, the asset names in the graph can be obfuscated, and vulnerabilities, risk findings, and descriptions can be extracted. As similarly discussed above, one of the technical challenges is to provide the graph in a form that can be provided within a limited size context window of a generative model (e.g., LLM). As such, the attack path graph is compressed by providing a linearized graph context to facilitate fitting the graph input within the context size of a given LLM as similarly described above and as will now be further described below.

In an example implementation, the attack path graph is compressed using the below described techniques. As a first example technique for compressing the attack path graph, redundant information can be removed from the graph. Specifically, we observed repeated labels and content in these attack path graphs. As such, removing these repeated labels and content can be performed to effectively and efficiently reduce the size of the graph.

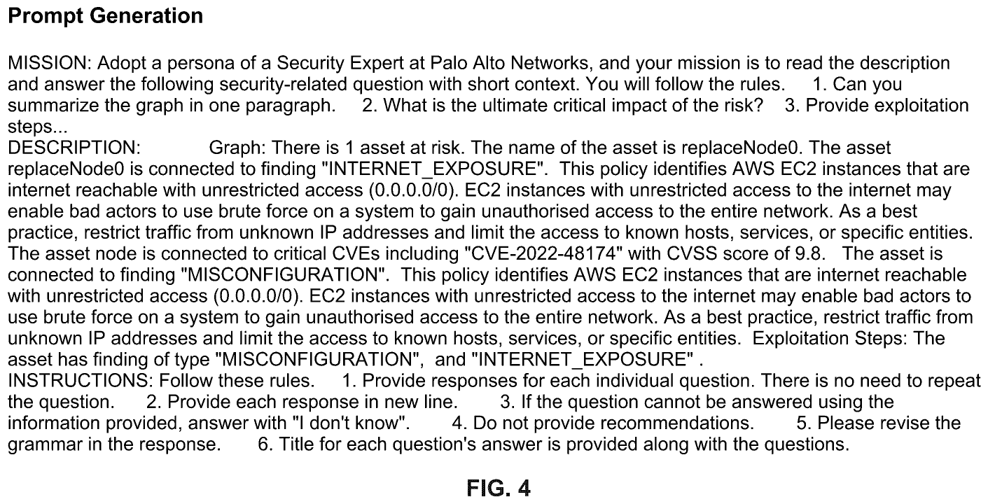

Also, as similarly described above, we can linearize the graph (e.g., from a JSON, such as shown in FIG. 4, or other format) to a text format. Specifically, the graph can be transformed into linear text by extracting nodes and edges and automatically generating a natural language sentence for each of them by using a predefined template, such as provided below.

<Node A> is connected to <Node B> with relationship type <Internet Exposure>.

In our example attack path graphs, nodes are the assets, and Internet gateways, buckets, and the relationships are vulnerabilities and attack techniques.

In an example implementation, linearizing the graph includes performing the following operations.
(1) Extract the asset nodes, the nodes at risk, present in the graph.
(2) Get the description about the asset including what type of asset it is. For example, is it an EC2 instance, a role, or an S3 bucket.
(3) Extract the CVE nodes present in the graph.
(4) Get the CVE description for these CVEs from a CVE repository (e.g., CVE data store 110 as shown in FIG. 1).
(5) Rank the CVEs based on the CVSS Score, exploitability, and patch availability.
(6) Extract the findings present in the graph.
(7) Get the finding descriptions for the findings from a findings repository.
(8) Extract the network gateways present in the graph.
(9) Extract the paths leading to buckets from the graph.
(10) Merge all the information together into a paragraph.
(11) Obfuscate all of the asset names, role names, gateways, s3 buckets, etc.

Finally, we can then send the linearized graph along with prompts and guardrails to the LLM to generate a response output that includes the summary, critical risk, and the exploitation steps, as will now be further described below.

At 210, preparing the context is performed by adding questions and guardrails along with the input graph for providing as context to the decoder model (e.g., LLM) for performing an inference. Specifically, in this example implementation, the added questions include a set of predetermined prompts. More specifically, prompting is used for packing intent in a natural language to cause the decoder model (e.g., LLM) to return the desired responses (e.g., and reducing the risks of hallucinations, etc.). In this example implementation, an appropriate set of prompts is identified to query the LLM along with the linearized graph context to elucidate the risks associated with the dynamic attack path graph input. Examples of such prompts are shown in FIG. 5 as will be further described below.

In this example implementation, the guardrails can be applied to obfuscate the private information present in the graph context, by for example, replacing actual values, such as asset names, with random values. The actual values can be mapped to such random values (e.g., stored in a cache) to facilitate reverting the original/actual values after performing the inference using the decoder model, such as shown at 216 as described below. Also, the guardrails can include a set of rules that facilitate the generative model performing the role of a threat expert and generating answers in a specific structure, and to not generate answers when the facts are not present in the context (e.g., to avoid hallucinations by the generative model/LLM). The disclosed microservice/system prepares the input to the generative model, referred to as context, for in-context learning, by merging the linearized graph, prompts, and the guardrails together. The context is sent to the generative model as a query (e.g., via the generative model API as shown at 214 as described below) to generate an explanation, such as will now be further described.

At 214, a generative model (e.g., LLM) API is called. In this example implementation, the context provided to the generative model includes the above-described predetermined prompts along with the linearized graph context.

In this example implementation, a decoder-only generative pretrained model (e.g., LLM) can be used as a response generator. These models are generally trained on a large dataset and are designed to generate content. The generative model is queried with the disclosed example contextual prompts to generate the answers to the questions provided in the context. The disclosed methodology is effective in elucidating helpful and factual summaries of these linearized graph context inputs independent of the model architecture that is utilized, including for example, open source generative models (e.g., the Meta Llama models, which are publicly available at https://llama.meta.com/) and/or the closed source/proprietary generative models that are commercially available (e.g., Claude from Anthropic PBC available at https://www.anthropic.com/claude, Gemini/text-Bison from Alphabet Inc. available at https://cloud.google.com/vertex-ai/generative-ai/docs/learn/models, and/or ChatGPT from OpenAI available at https://openai.com/chatgpt/) models.

At 216, the response from the generative model is received and the output is prepared. Specifically, as similarly described above with respect to FIG. 1, the obfuscated asset names are replaced with the actual values, and the output is checked to verify that it is correctly formatted.

At 218, the output is pushed to the user interface (UI)/user experience (UX) (e.g., pushing the output to the UI/UX in less than 1024 words). For example, a summary of the graph can be provided in one paragraph and include all of the asset names associated with any identified risks. The summary can also include any identified critical risks (e.g., an ultimate critical impact of a combination of risks associated with the dynamic attack path graph). The summary can also include exploitation steps, as similarly described above, to provide step-by-step details on how an attacker could chain all alerts in the asset description for attack.

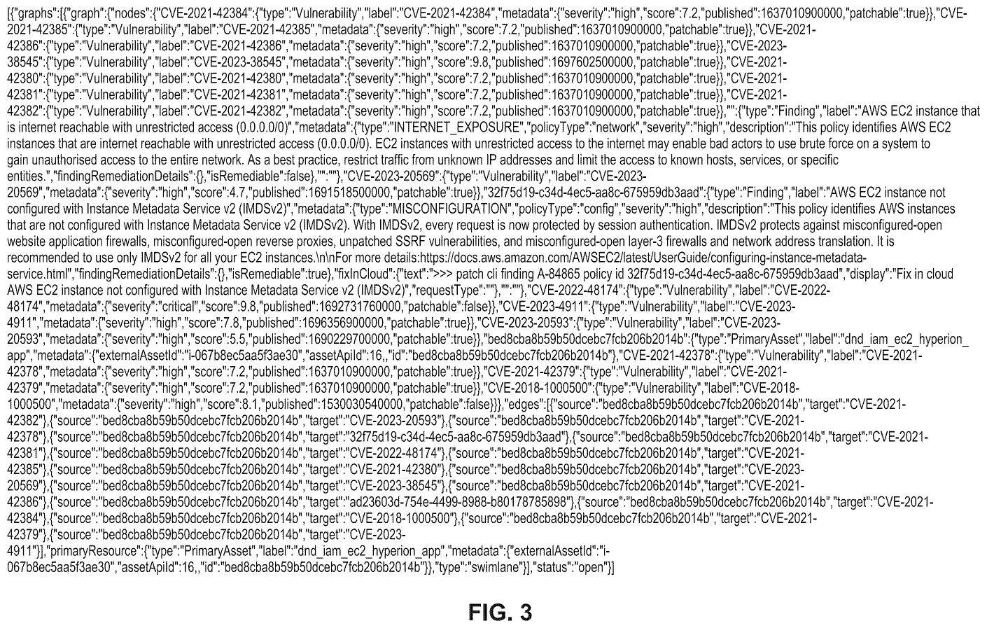

At 220, the results are rendered in the UI/UX of the service (e.g., a Copilot security service, such as provided by Palo Alto Networks, Inc., headquartered in Santa Clara, CA) for the user to view in response to their original query (202). An example output of results is shown in FIG. 3 as described below.

FIG. 3 illustrates an example attack path graph in JSON format in accordance with some embodiments.

FIG. 4 illustrates an example prompt generation in accordance with some embodiments. As shown, the example prompt provided to the generative model (e.g., LLM) includes instructions and rules for, in part, the following: (1) summarizing the graph in one paragraph; (2) identifying the critical impact of the risk; and (3) providing the exploitation steps.

FIG. 5 illustrates an example generative model response in accordance with some embodiments. As shown, the example response provided by the generative model (e.g., LLM) includes the following: (1) a summary of the graph in one paragraph; (2) an identification of the critical impact of the risk; and (3) the exploitation steps.

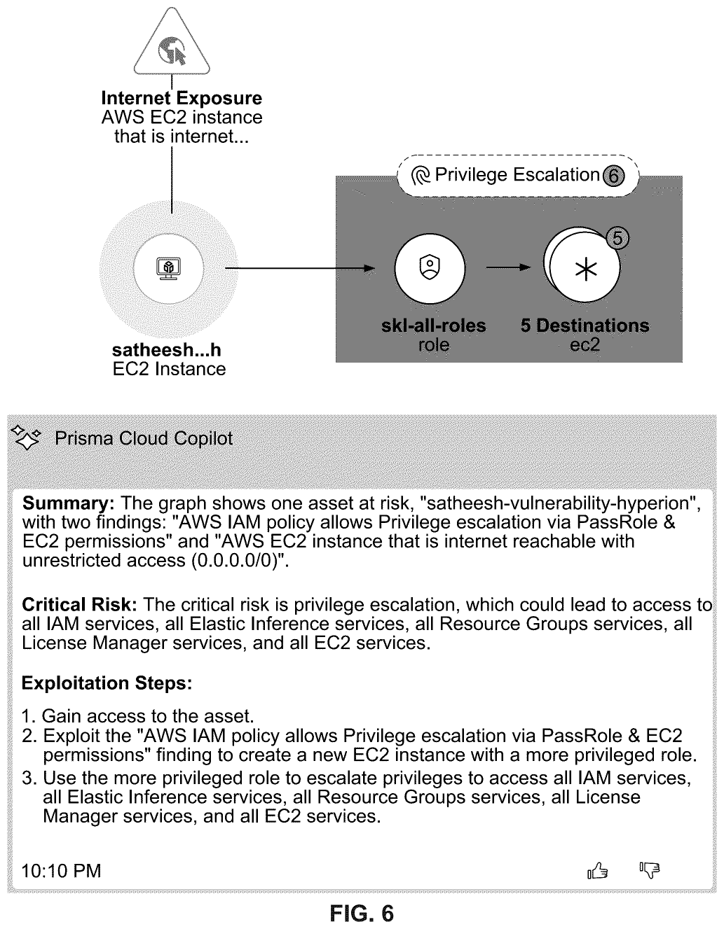

FIG. 6 illustrates an example output of a system for a privacy-aware dynamic attack path explainer solution in accordance with some embodiments. As shown in FIG. 3, an example attack graph is summarized. Specifically, a summary of the graph is provided in one paragraph and includes all of the asset names associated with any identified risks. The summary also includes any identified critical risks (e.g., an ultimate critical impact of a combination of risks associated with the dynamic attack path graph). The summary also includes the exploitation steps, as similarly described above, to provide step-by-step details on how an attacker could chain all alerts in the asset description for attack.

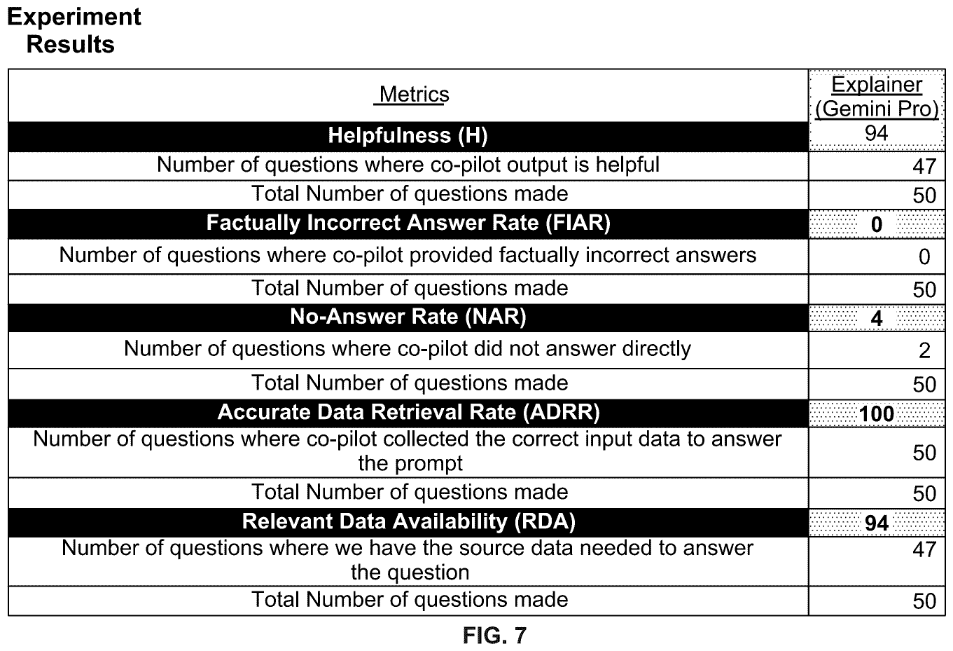

FIG. 7 illustrates example results of experiments performed using the privacy-aware dynamic attack path explainer solution in accordance with some embodiments. As shown, in this experiment, the LLM utilized by the privacy-aware dynamic attack path explainer solution was the Gemini Pro LLM that is commercially available from Alphabet Inc. Based on these experiments, the disclosed co-pilot solution was able to provide helpful responses to 47 out of 50 questions and provided no factually incorrect answers.

Additional process embodiments and techniques for providing a privacy-aware dynamic path explainer will now be further described below.

### Example Process Embodiments for Providing a Privacy-Aware Dynamic Path Explainer

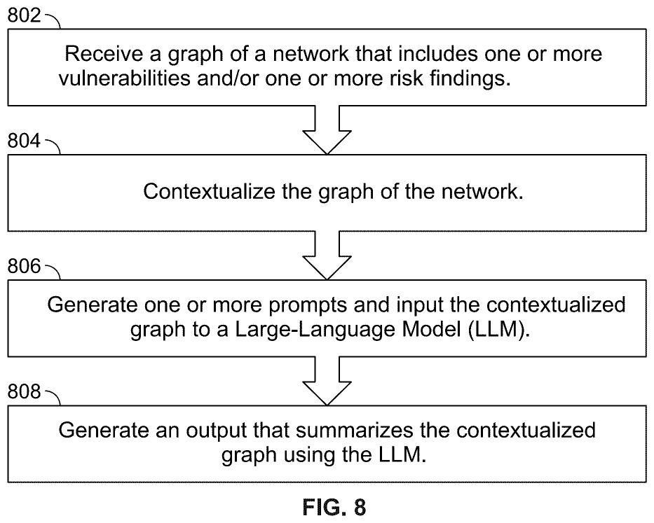

FIG. 8 is a flow diagram for a process for providing a privacy-aware dynamic path explainer in accordance with some embodiments. In some embodiments, a process as shown in FIG. 8 is performed by the system/service and techniques as similarly described above including the embodiments described above with respect to FIGS. 1-6.

At 802, a graph of a network that includes one or more vulnerabilities and/or one or more risk findings is received, such as similarly described above with respect to FIGS. 1 and 2. For example, the graph of the network can also include one or more systems and/or one or more misconfigurations.

At 804, contextualizing the graph of the network is performed, such as similarly described above with respect to FIGS. 1 and 2.

At 806, generating one or more prompts and inputting the contextualized graph to a Large-Language Model (LLM) are performed, such as similarly described above with respect to FIGS. 1, 2, and 4.

At 808, generating an output that summarizes the contextualized graph using the LLM is performed, such as similarly described above with respect to FIGS. 1, 2, 5, and 6.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive a graph of a network that includes one or more vulnerabilities and/or one or more risk findings;
contextualize the graph of the network;
generate one or more prompts and input the contextualized graph to a Large-Language Model (LLM); and
generate an output that summarizes the contextualized graph using the LLM; and
a memory coupled to the processor and configured to provide the processor with instructions.

2. The system of claim 1, wherein tenant proprietary data is obfuscated in the graph prior to inputting the graph into the LLM.

3. The system of claim 1, wherein an attack path explanation is included in the output that summarizes the contextualized graph using the LLM.

4. The system of claim 1, wherein a critical path explanation is included in the output that summarizes the contextualized graph using the LLM.

5. The system of claim 1, wherein an alert explanation is included in the output that summarizes the contextualized graph using the LLM.

6. The system of claim 1, wherein guardrails are used to reduce hallucinations in the output generated using the LLM.

7. The system of claim 1, wherein the one or more prompts include one or more predetermined prompts that are input to the LLM.

8. The system of claim 1, wherein the graph is stored in a JavaScript Object Notation (JSON) format for input and/or output.

9. The system of claim 1, wherein contextualizing the graph of the network further comprises:
compressing the graph.

10. The system of claim 1, wherein the processor is further configured to:
ground information in context input to the LLM based on a predetermined set of Common Vulnerabilities and Exposures (CVEs).

11. A method, comprising:
receiving a graph of a network that includes one or more vulnerabilities and/or one or more risk findings;
contextualizing the graph of the network;
generating one or more prompts and inputting the contextualized graph to a Large-Language Model (LLM); and
generating an output that summarizes the contextualized graph using the LLM.

12. The method of claim 11, wherein tenant proprietary data is obfuscated in the graph prior to inputting the graph into the LLM.

13. The method of claim 11, wherein an attack path explanation is included in the output that summarizes the contextualized graph using the LLM.

14. The method of claim 11, wherein a critical path explanation is included in the output that summarizes the contextualized graph using the LLM.

15. The method of claim 11, wherein an alert explanation is included in the output that summarizes the contextualized graph using the LLM.

16. A computer program product embodied in a non-transitory computer readable medium and comprising computer instructions for:
receiving a graph of a network that includes one or more vulnerabilities and/or one or more risk findings;
contextualizing the graph of the network;
generating one or more prompts and inputting the contextualized graph to a Large-Language Model (LLM); and
generating an output that summarizes the contextualized graph using the LLM.

17. The computer program product of claim 16, wherein tenant proprietary data is obfuscated in the graph prior to inputting the graph into the LLM.

18. The computer program product of claim 16, wherein an attack path explanation is included in the output that summarizes the contextualized graph using the LLM.

19. The computer program product of claim 16, wherein a critical path explanation is included in the output that summarizes the contextualized graph using the LLM.

20. The computer program product of claim 16, wherein an alert explanation is included in the output that summarizes the contextualized graph using the LLM.
